(19) United States
(12) Patent Application Publication
(10) Pub. No.: US 2018/0276584 A1
(43) Pub. Date: Sep. 27, 2018

(54) FACILITATING ORGANIZATIONAL MANAGEMENT USING BUG DATA

(71) Applicant: MICROSOFT TECHNOLOGY LICENSING, LLC, Redmond, WA (US)

(72) Inventors: Muiris Woulfe, Dublin (IE); Poornima Muthukumar, Seattle, WA (US); Yuanyuan Dong, Bellevue, WA (US)

(21) Appl. No.: 15/469,431

(22) Filed: Mar. 24, 2017

(51) Int. Cl. G06Q 10/06; G06F 11/36; G06F 9/44

(52) U.S. Cl. CPC G06Q 10/0635; G06Q 10/06398; G06F 8/36; G06F 11/362

(57) ABSTRACT

A risk factor that software written by a developer includes bugs can be calculated for the developer. The risk factor can be used to determine the quality of the developer's code. The risk factor associated with code produced by a particular developer can be provided to a manager or management system. The risk factor can be used to provide bug-based information to a corporate review and reward process.

### CROSS-REFERENCE TO RELATED APPLICATIONS

The application is related in subject matter to co-pending U.S. patent application Ser. No. ______ (Docket No. 362062.01/401338-US-NP) entitled “ENHANCING SOFTWARE DEVELOPMENT USING BUG DATA”, filed on ______. The application is related in subject matter to co-pending U.S. patent application Ser. No. ______ (Docket No. 362318.01-401596-US-NP) entitled “BUG CATEGORIZATION AND TEAM BOUNDARY INFERENCE VIA AUTOMATED BUG DETECTION”, filed on ______. The application is related in subject matter to co-pending U.S. patent application Ser. No. ______ (Docket No. 362316.01-401598-US-NP) entitled “IMPROVING ENGINEERING SYSTEM ROBUSTNESS USING BUG DATA”, filed on ______. This application is related in subject matter to co-pending U.S. patent application Ser. No. 15/362,744 entitled “SOURCE CODE BUG PREDICTION” filed on Nov. 28, 2016.

### BACKGROUND

Many organizations employ some form of organizational or corporate review and rewards system. In most cases, an employee is asked to write a report of what he or she achieved during the year. The report is reviewed by management and used to decide matters such as pay increases, bonuses, stock awards, promotion, etc. In many cases, the organizational or corporate review process incorporates metrics for various business processes related to the employee's work.

### SUMMARY

A risk factor for software written by a particular developer or group of developers can be calculated where the risk factor is a measure of the likelihood that the software written by a specified developer or specified group of developers includes bugs. The risk factor can be based on historical bug data, bug prediction data and/or bug identification data. The software written by the developer or group of developers can be extracted from one or more software repositories, based on an identifier of the author(s) of the software stored in the repository or repositories.

The risk factor associated with code produced by the specified developer or specified group of developers can be provided to a manager or management system. The management system can be a human resources (HR) management system. The risk factor can be used to provide bug-based information to a corporate review and rewards process. Risk results (e.g., risk factor or combination of risk factors) can be used to determine the quality of a specified developer's code and/or or the quality of the code written by the specified group of developers. Rewards can be applied automatically in accordance with bug data. Rewards can include but are not limited to promotions, stock options, pay increases, increases in vacation time, etc. Visualizations can be provided. Notifications can be generated. Notifications can be sent automatically. The probability that code created by a particular developer includes bugs can be graphed or ranked, as a way of assessing performance of the developer.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1a is a block diagram illustrating an example of a system 100 for improving organizational management using bug data in accordance with aspects of the subject matter disclosed herein;

FIG. 1b is an illustration of an example of an internal representation of bug data associated with a developer in accordance with aspects of the subject matter disclosed herein;

FIG. 1c is an illustration of an example of a visualization 160 of ranking bug data associated with a group of developers in accordance with aspects of the subject matter disclosed herein;

FIG. 1d is an illustration of an example of a visualization of ranked bug data associated with a developer and manager's comments in accordance with aspects of the subject matter disclosed herein;

FIG. 1e is an illustration of an example of a visualization 165 of bug data associated with a developer, manager's comments and management action in accordance with aspects of the subject matter disclosed herein;

FIG. if is an illustration of an example of a form for an employee response in accordance with aspects of the subject matter disclosed herein;

FIG. 2 is a flow diagram of an example of a method 200 for facilitating organizational management using bug data in accordance with aspects of the subject matter disclosed herein;

FIG. 3 is a block diagram of an example of a computing environment in accordance with aspects of the subject matter described herein.

### DETAILED DESCRIPTION

### Overview

A risk factor that code written by a developer or group of developers includes bugs can be generated for a developer or group of developers based on bug data including bug detection data, historical bug data and/or bug prediction data. Bug detection is the process of detecting bugs. The bug data can be used to determine the risk that program source code written by a specified developer includes bugs. The bug data can be used to determine the risk that program source code written by a specified group of developers includes bugs.

A risk factor for software written by a particular developer or group of developers can be calculated where the risk factor is a measure of the likelihood that the software written by a specified developer or specified group of developers includes bugs. The risk factor for a specified developer can be determined by combining the risk factor of each line of code the developer has written, using one of various mathematical formulae. The risk factor for a group of developers can be computed by combining the risk factor of each line of code the group of developers has written. The risk factor can be computed for a specified timeframe. A risk factor for software written by the developer or group of developers can be based on historical bug data, bug prediction data and/or bug identification data.

The software written by the developer or group of developers can be extracted from one or more software repositories, based on an identifier of the author(s) of the software stored in the repository. If the data comes from more than one software repository, the data from all the repositories can be aggregated. The data from the different repositories can be combined using the mathematical formulae such as but not limited to an average, mean or summation. One appropriate formula would be a computation of the mean risk factor over all the lines created by an author added to the maximum per-line risk factor. This has the advantage of finding the average risk over the given set of changes, while adding the maximum to account for an exceptionally large maximum risk that could add serious risk to the changes not considered via the mean alone.

The risk factor can be calculated when the code is committed. The risk factor can be used by a management system to: rank proficiency among a group of developers or between groups of developers, determine the quality of the specified developer's code, determine the quality of the code written by the specified group of developers, etc. The risk factor associated with code produced by the specified developer or specified group of developers can be provided to a manager or management system and can be used to provide bug-based information to a corporate review and reward process.

The risk factor can be used by a manager, a supervisor, etc. to determine a developer's level of code quality. Performance comparison information can be used to rank developers. The performance comparison information or portions thereof can be provided to a team of developers. Underperformers and/or others in the group can be shown a comparison of their results to others in the group. The others can be identified or can be anonymous. The performance comparison can be provided to encourage the improvement of code quality, for purposes of a competition or for any other reason.

The performance of a developer over time can be tracked. The tracking data can be stored in the software repository or other system such as a database system or human resources (HR) system. For example, a developer whose code quality has decreased can be identified. Similarly a developer whose code quality has increased can be identified. Changes in code quality for a developer can be tracked over time to provide a view of changes in quality over time.

Metrics used to determine the probability of code including bugs can be used to perform a data-driven determination of rewards. The metrics can be used as the sole determination criteria or can be combined with other decision making processes. Decision making processes can include manager observations. This can allow for the capture and consideration of those elements of an employee's work not captured by metrics. Some of the information may come from an external source or sources. The information can be provided within a review and/or rewards system. The information can be provided for discussion during a review. The information can be used to automatically dismiss an employee whose performance falls below a threshold of acceptable performance Automatic dismissal can occur during a review timeframe, or at any other time. Automatic promotion can occur during the review timeframe, or at any other time.

In accordance with some aspects of the subject matter disclosed herein, a risk determination program module can calculate the risk factor for each developer representing the likelihood that the developer's code includes bugs. The information can be provided to a management system in response to a request from the management system (e.g., using a JSON RESTful web service called for each developer individually or called for all the desired developers at once). In accordance with other aspects of the subject matter described herein, one or more source code repositories can connect to the management system and send the risk factors.

Notifications can be generated. Notifications can be sent automatically. Notifications can be sent to a developer, administrator, supervisor, manager or other individual. Notifications can be generated and sent based on settings provided to the management system. Notifications can be delivered through toast notifications, dialog boxes, confirmation prompts, email, social network posts, instant messages, SMS messages, telephone calls and so on.

Notifications can be provided to developers who are outside of the normal range (e.g., to a developer introducing code whose code exceeds a risk threshold or that falls below a safe threshold). The risk factor can be calculated when the code is committed. Notifications can be provided to developers who have dropped below a specified threshold of quality. A way to respond to the allegations can be provided. A response can be provided through online forms, dialog boxes, etc.

Visualizations of risk can be provided. A table or bar chart, histogram or other type of graph showing the performance of the different developers on a team can be provided. Changes in code quality for a developer can be tracked over time to provide information concerning the developer's changes in code quality over time. This information can be provided in a line chart or other suitable visualization.

If multiple source-code repositories exist, the data from all the repositories can be aggregated, thereby providing a single entry point for the management system, and ensuring that all the data for a single developer across multiple disparate repositories are captured. The data from the different repositories can be combined using the mathematical formulae outlined previously.

Developer performance can be captured from one or a combination of systems internal to an organization. Developer performance can be captured from one or a combination of systems external to an organization. A developer may have contributed code to the external source. For example, the developer may have contributed code to an open source code repository such as one hosted by GitHub.

It will be appreciated that although described in the context of software bugs, the subject matter disclosed herein is not so limited. A set of hardware changes made by the developer or group of developers can be identified using a hardware description language. A risk factor for hardware changes specified by the developer or group of developers can be based on the risk factor assigned to each hardware component specified by the developer or group of developers.

### Facilitating Organizational Management Using Bug Data

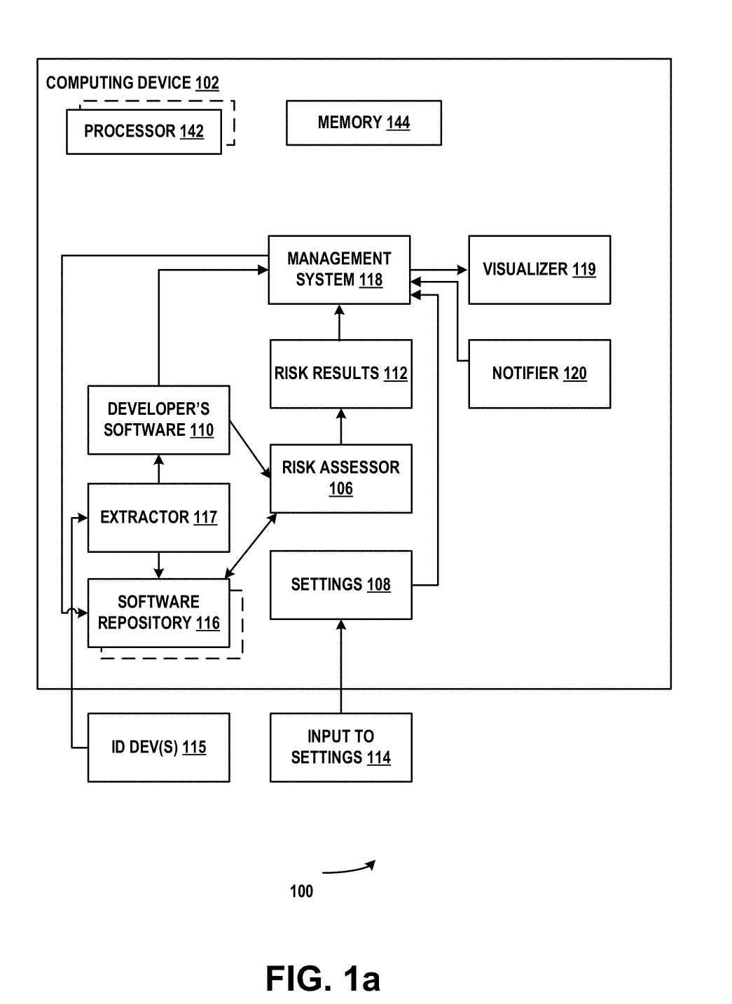

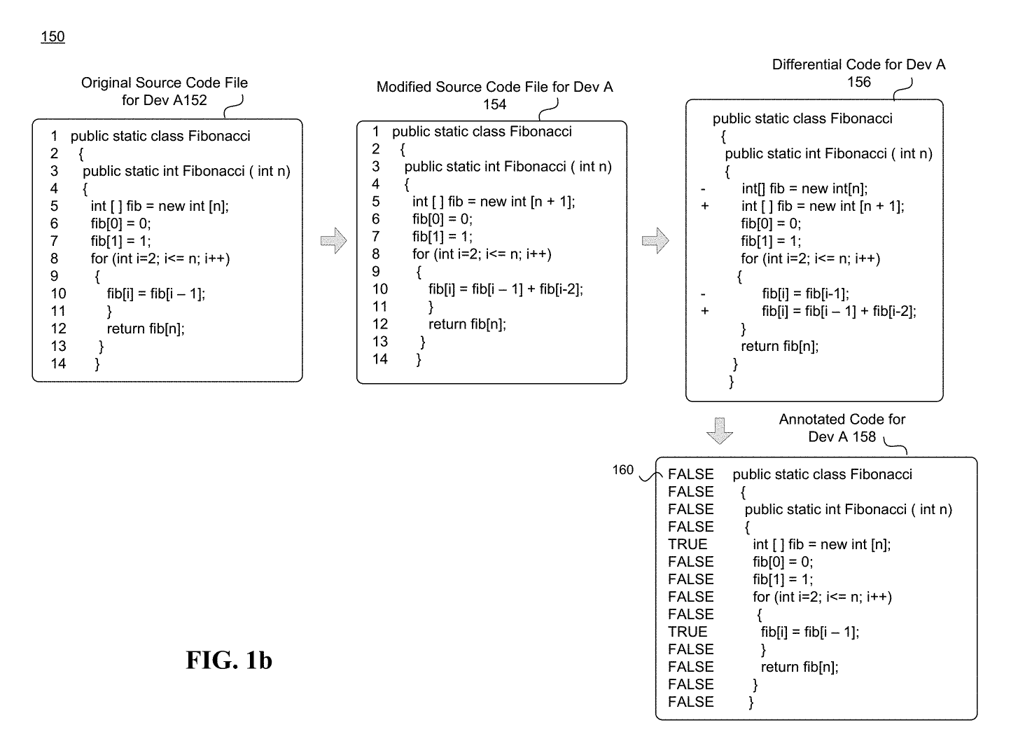

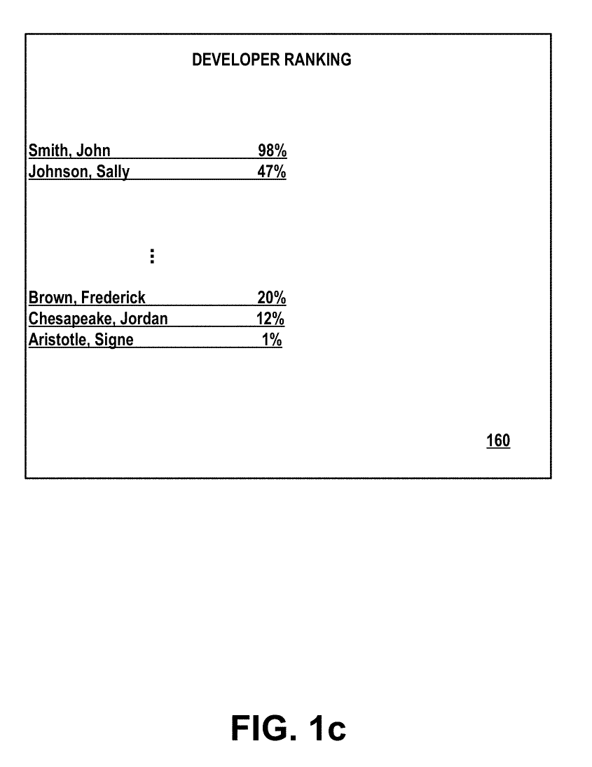

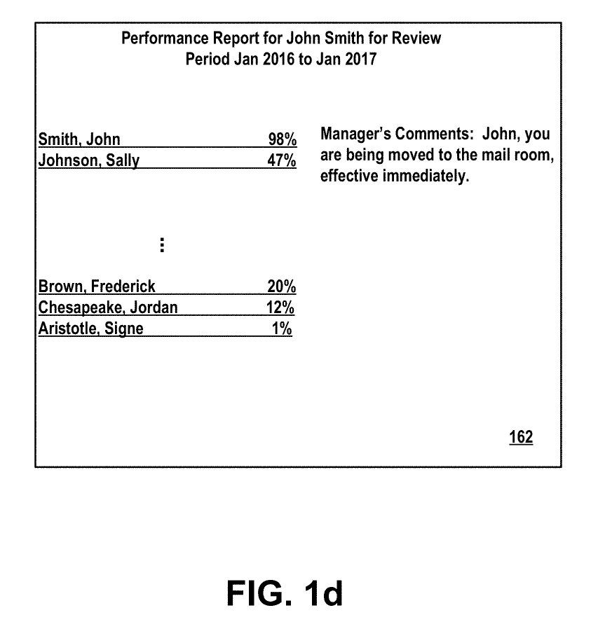

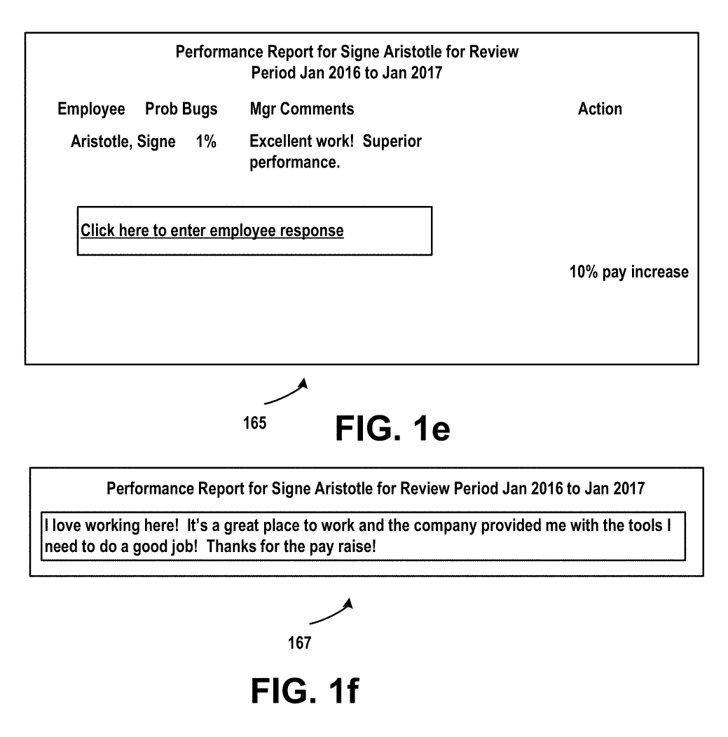

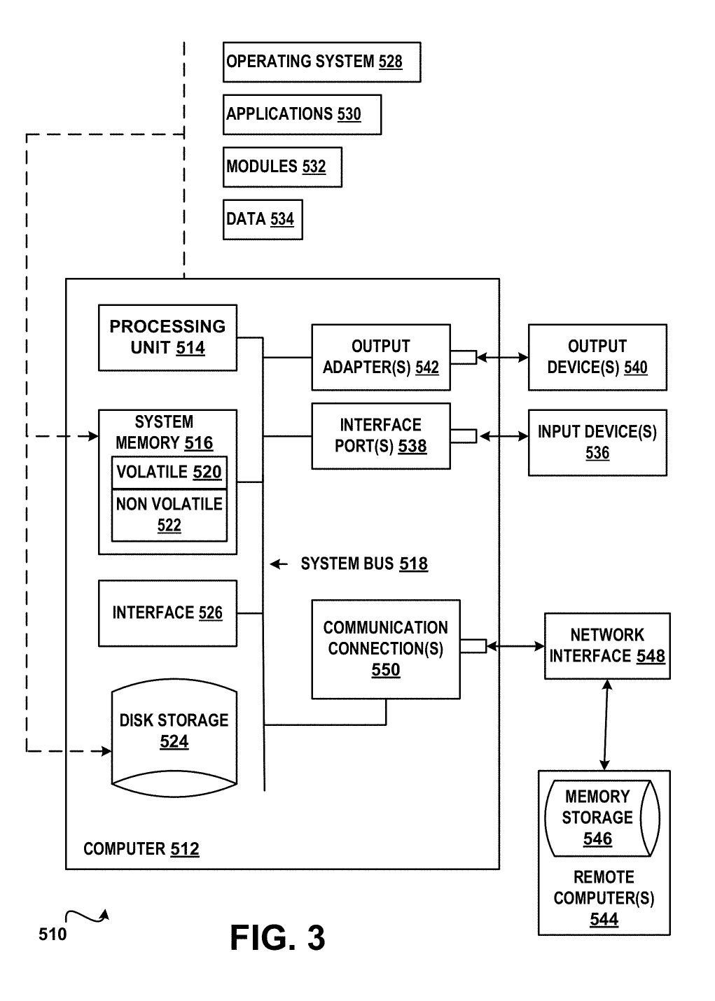

FIG. 1a is a block diagram illustrating an example of a system for facilitating organizational management using bug data in accordance with aspects of the subject matter disclosed herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud. System 100 can be an on-premises system.

System 100 can include one or more computing devices. Contemplated computing devices include but are not limited to desktop computers, tablet computers, laptop computers, notebook computers, personal digital assistants, smart phones, cellular telephones, mobile telephones, sensors, server computers, client computers and so on. A computing device such as computing device 102 can include one or more processors such as processor 142, etc., and a memory such as memory 144 that communicates with the one or more processors.

System 100 may include one or more program modules that when loaded into the memory and accessed by the one or more processors cause the processor to perform the action or actions attributed to the one or more program modules. The processor(s) may be configured to perform the action or actions attributed to the one or more program modules. System 100 may include any one of or any portion of or any combination of any number of the following: a risk assessing module or risk assessor such as risk assessor 106, a software extracting module such as extractor 117, a setting module such as settings 108, a visualizer such as visualizer 119, a notification module such as notifier 120 and/or a management module such as management system 118.

The extractor 117 can receive an identifier for a developer or a group of identifiers for a group of developers (ID DEV(S) 115) and can extract software written by the identified developer(s) from one or more software repositories such as software repository 116, etc. The extracted software such as developer's software 110 can be provided to a risk assessor such as risk assessor 106. The risk assessor 106 can produce risk results such as risk results 112. Risk results 112 can be provided to a management system such as management system 118. The management system 118 can receive settings from a settings module such as settings 108. Settings can be defined by input received comprising input to settings 114. The management system 118 can output visualizations from visualizer 119 and notifications such as notifications 120 in accordance with the settings 108.

A software repository 116, etc. can include software written by a plurality of software writers such as but not limited to developers. The source code within the software repository 116, etc. can be annotated with an identifier of the writer of the software. The software repository 116, etc. may track changes made to source code. The changes may be attributed to fixing bugs. Bug data can be entered into the software repository 116, etc. manually, can be entered into the software repository 116, etc. by a program or can be predicted by a machine learning and/or statistical analysis system and entered into the software repository 116, etc. A machine learning and/or statistical analysis system (not shown) can receive labeled or unlabeled, buggy or bug-free data and can infer whether source code is buggy or bug-free.

The software repository 116, etc. can provide warnings that source code being added to the repository is buggy automatically on commit, on integrate, on deliver/deploy), on a scheduled job, or on request by, for example, a manager. The warnings of the software repository 116, etc. can be overridden. The software repository 116, etc. can track the results of overriding the warnings. Actions taken to warnings can be recorded along with information concerning failed deployments or deliveries, a higher than normal customer failure rate after deployment or delivery or through manual data entry. If a particular individual overrides a warning and the override results in adverse results, the failure information can be provided to the management system 118.

The source code repository may be a version control system such as Apache Subversion or Git. However, the subject matter disclosed herein is not limited to a source code repository and other sources containing source code may be utilized as well. For example, without limitation, the data mining engine may search source code files belonging to a particular project in an integrated development environment (IDE), and/or search source code files associated with a particular storage location (e.g., directory/folder, cloud storage, etc.). It is to be understood that wherever the term “repository” is used, any of the possible sources can be employed.

An extracting module such as extractor 117 can receive an identifier of a developer or a list of identifiers of developers 115. The extractor 117 can extract software written by the identified developer(s). The extractor 117 can extract bug data associated with the identified developer(s) from the one or more software repositories, etc.

Extracted software such as developer's software 110 can be received by a risk assessor 106. The risk assessor 106 may determine the risk that the extracted developer's software 110 includes bugs. Risk can be determined using bug data. Bug data can include any combination of: bug detection data, historical bug data and/or bug prediction data. Bug detection is the process of detecting bugs. Bug detection can involve manual detection. Bug detection can involve an automated process. An automated process can identify buggy code. Historical bug data is data concerning what caused bugs in the past.

Bug prediction is the use of a machine learning and/or statistical analysis system to analyze characteristics of the code to predict the presence or absence of bugs. The subject matter disclosed herein can utilize different techniques for extracting features of source code with software bugs and features of source code that do not have software bugs. In accordance with some aspects of the subject matter disclosed herein, each element in a line of source code can be converted into a token that represents the element. The line of source code can be represented as a sequence of tokens. The sequence of tokens can be grouped into a window or group that includes sequences of tokens in an aggregated collection of contiguous source code statements. The sequences in a window can be transformed into a binary representation which forms a feature vector that trains a machine learning model, such as a long short-term model (LSTM). Long short-term memory (LSTM) is a recurrent neural network (RNN) architecture that is well-suited to learn from experience to classify, process and predict time series when there are time lags of unknown size and bound between significant events.

In accordance with other aspects of the subject matter disclosed herein, a source code file can be partially tokenized with each line of source code including a combination of tokens and source code. Each line of source code can be analyzed on a character-by-character or chunk-by-chunk basis to identify characters or chunks that are associated with and are not associated with software bugs. A chunk, as used herein, has a predetermined number of characters. Contiguous chunks of source code can be grouped into a window which can be converted into a binary representation that forms feature vectors that train a machine learning model, such as a recurrent neural network (RNN).

In accordance with other aspects of the subject matter disclosed herein, metrics representing a measurement of syntactical elements of a source code file can be collected. The metrics can include the number of variables, the number of mathematical operations, the number of a particular data type referenced, the number of loop constructs, the usage of a particular method, the usage of a particular data type and/or the complexity of the block of code such as, for example, computed by O(n), O(n²), O(n³), etc. Computational complexity is a way of classifying computational problems according to their inherent difficulty. O(n) means iteration over all n objects under consideration a single time as in, for example, a standard loop. O(n²) means iteration over all n objects for each iteration of the O(n) loop. O(n³) means iteration over all n objects for each iteration of the O(n²) loop.

Metrics can be collected for each line of source code, for each method in a source code file, for each class in a source code file, and/or in other groupings. The metrics can be converted into a binary representation that forms feature vectors which can be used to train a machine learning model such as an artificial neural network (ANN).

The feature vectors can be constructed from source code files having a software bug and source code files without a software bug. The feature vectors can be split into data that is used to train the machine learning model and data that is used to test the machine learning model. The model can be used to predict the probability of the presence of a category of software bug in a source code file.

A risk assessor such as risk assessor 106 can receive buggy and bug free code from the extractor 117 and can calculate a risk factor. The calculated risk factor can be a measure of the likelihood that the software received from the extractor 117 is buggy (i.e., includes bugs). The calculated risk factor can be for software written by a particular developer when a single developer identifier 115 is received. The calculated risk factor can be for software written by a group of developers when a group of developer identifiers are received.

The risk factor for a developer or group of developers can be calculated using a mathematical formula such as but not limited to an average, mean or summation. The risk factor for a specified developer can be determined by combining the risk factor of each line of code the developer has written. The risk factor for a group of developers can be computed by combining the risk factor of each line of code the group of developers has written. The risk factor can be computed for a specified timeframe, e.g. for the past year, for a review period, etc. The risk factor can be computed as an on-going calculation.

A risk factor for hardware changes made by an identified employee or group of employees can be computed using a hardware description language. The risk assessor 106 can output risk results 112. Risk results 112 can be provided, for example, as a percentage representing the likelihood that a line of source code includes a bug. Risk results 112 can be provided to a manager or management system such as management system 118. Management system 118 can use risk results 112 to determine the quality of a specified developer's code. Management system 118 can use risk results 112 to determine the quality of the code written by a specified group of developers. Management system 118 can use risk results 112 to rank proficiency of an identified developer among a group of developers.

Management system 118 can use risk results 112 to rank proficiency of groups of developers. Bug data can be included to automatically determine rewards levels. Automated decisions about management actions including dismissal, promotion, giving awards and so on can be based in whole or in part on bug data. Rewards can include pay rises, stock awards, etc., can be based in whole or in part on bug data. Risk results 112 can be used to determine the quality of a specified developer's code. Risk results 112 can be used to determine the quality of the code written by the specified group of developers. The risk results can be used to provide bug-based information to a corporate review and reward process. The probability that code written by the specified developer includes bugs can be used to assess the performance of the specified developer. The probability that code written by the specified group of developers includes bugs can be used to assess the performance of the specified group of developers.

Notifications can be generated by a notification module such as notifier 120. Management system 118 can direct the notifier 120 to send notifications. Notifications can include risk results. Notifications can be sent automatically. Notifications can be sent automatically based on received settings. Notifications can be provided via toast notifications, dialog boxes, confirmation prompts, email, social network posts, instant messages, SMS messages and/or telephone calls.

Notifications can be sent to an administrator, supervisor, manager or other individual or group of individuals. For example, a notification can be automatically sent to a developer (via email, instant message or other). The tool may automatically contact the developer's administrator, supervisor, manager or other individual. The tool may automatically contact a developer (via email, instant message or other means) or the developer's administrator, supervisor, manager or other individual if his or her code exceeds a specified threshold of risk and/or if his or her code is deemed sufficiently risk free.

Visualizations can be generated by a visualization module such as visualizer 119. Management system 118 can direct the visualizer 119 to create and send visualizations such as but not limited to those illustrated in FIGS. 1c, 1d, 1e and 1f. Bug data can be included in a visualization generated by the visualizer 119. Bug data in visualizations can be used to facilitate management tasks including but not limited to a review of the developer. Bug data can be included to automatically determine rewards levels. Automated or manual decisions about dismissal, promotion, pay rises, stock awards, etc., can be based in whole or in part on bug data.

A table or bar chart, histogram or other type of graph showing the performance of the different developers on a team can be provided. In accordance with some aspects of the subject matter disclosed herein, a visualization can be based on a comparison of the proportion of bugs introduced into code written by the specified developer to the specified group of developers to produce a ranking of developers based on the quality of the code the developers write. The probability that code written by the specified developer includes bugs can be used to assess the performance of the specified developer. The probability that code written by the specified group of developers includes bugs can be used to assess the performance of the specified group of developers.

Settings module 108 can receive input to settings 114. Settings can include one or more or any combination of: a setting comprising a threshold, a setting comprising a time period, a setting indicating how risk results are combined, a setting identifying a person or persons to receive notifications, a setting identifying a person or persons to receive notifications, a setting identifying a person or person to receive risk results for a specified developer or group of developers. Threshold settings can include one or more or any combination of: a threshold for risk results which if exceeded results in dismissal of the developer, a threshold which if exceeded triggers a notification, a threshold which if exceeded triggers a visualization to be created, a threshold which if exceeded triggers a visualization to be sent, a threshold which if exceeded triggers the delivery of risk assessment results to a developer, a group of employees, a management system, a manager, supervisor or other and so on.

FIG. 1b illustrates an example of an internal representation 150 of historical bug data for a specified developer, developer A. In FIG. 1b, a portion of an original source code file 152 written in C# having 14 lines of code or source code statements is illustrated. For the purposes of this example, a source code statement is identified as being a continuous sequence of code elements that ends at a semicolon. This original source code file 152 can be stored in a source code repository. The original source code file 154 shows a modified version of the original source code file 152 which corrects two software bugs at lines 5 and 10.

The source code repository may track these changes and attribute them to bug fixes. Differential code 156 illustrates the differences between the original source code file 152 and the modified source code file 154 where the source code statement “int[ ] fib=new int[n]” is annotated with the “−” symbol indicating that the associated code statement was altered. In addition, program 156 shows the source code statement “int [ ] fib=new int [n+1]” annotated with a “+” symbol indicating that the associated code statement is the modification. The tracked changes of a source code file (i.e., change sets) can be annotated with a flag that indicates whether or not each source code statement includes a bug. This can be done manually, programmatically (e.g., using a bug tracker) or by a machine learning and/or statistical analysis system. For example, the annotated code 158 represents the original source code file 152 annotated with a flag such as flag 160 at each line, where the flag “FALSE” denotes that there is no bug in a source code statement, the flag “TRUE” denotes a software bug is in the source code statement.

FIG. 1c is an illustration of an example of a visualization 160 of ranking bug data associated with a group of developers in accordance with aspects of the subject matter disclosed herein. Visualization 160 displays a list of developers with their computed risk results in order from high to low.

FIG. 1d is an illustration of an example of a visualization 162 of a performance report in which the ranking bug data above associated with a group of developers is displayed in addition to the risk results for the developer and manager comments.

FIG. 1e is an illustration of an example of a visualization 165 of a performance report for a developer in which the risk results for the developer, manager comments and an action are displayed. FIG. 1f is an illustration of an example of a visualization 167 of a response to visualization 165.

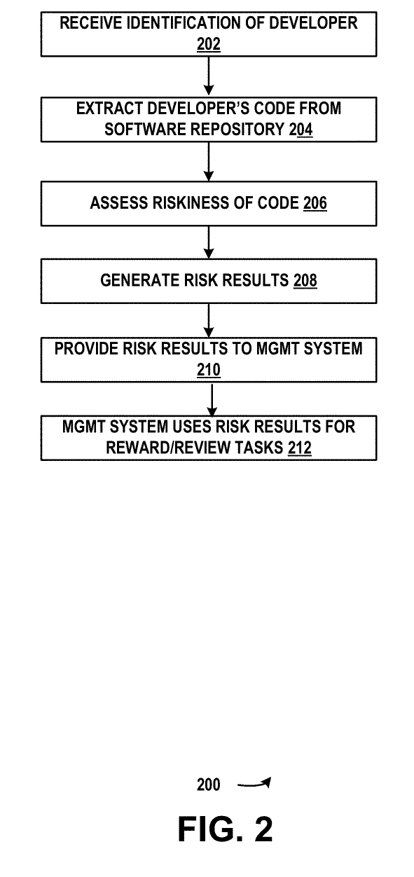

FIG. 2 is a flow diagram of an example of a method for improving organizational management using automated bug detection in accordance with aspects of the subject matter disclosed herein. The method described in FIG. 2 can be practiced by a system such as but not limited to the one described with respect to FIG. 1a. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. In some instances, not all operations performed are illustrated.

The management system can initiate the process described below. The repository can initiate the process described below. The management system can initiate the process described below. The repository can initiate the process described below. At operation 202 an identification of a developer or group of developers can be received. The identification information can identify one or more individuals for which to calculate a risk factor comprising the probability that code created by the identified includes bugs. At operation 204 bug data information can be extracted from a software repository, the extracted software comprising software code written by the identified developer or group of developers.

More than one software repositories can be accessed. If more than one software repository is accessed for the developer's bug data, the extracted data can be amalgamated. At operation 206 the risk that the developer's code can be assessed. At operation 208 the risk results can be generated. The risk assessor can calculate the risk results for a group of individuals identified by the request. At operation 210 the risk results can be provided to a management system. At operation 212 the management system can produce visualizations of the risk results. The management system can produce notifications that provide the risk results to others. The management system can use the risk results to evaluate performance of the developer or group of developers. The management system can initiate management actions based on the bug data.

### CONCLUSION

Described herein is a system including a memory, a processor connected to the memory, the processor configured to receive a request for a risk factor for an employee, the risk factor comprising a likelihood that software code written by the employee includes bugs, assess the risk factor for the employee using the bug data; and provide the risk factor to a human resources management system. The management system can use the risk factor for the employee to determine the quality of developer's code. A software repository comprising bug data for the employee can be accessed to compute the risk factor. The risk factor can be provided to a corporate review process. A plurality of software repositories can be accessed for bug data to determine a risk factor for the employee. The system can produce one or more visualization. One visualization can indicates the probability that code created by the employee includes bugs. The risk factor can be used to automatically determine reward levels. Described herein is a method in which a processor of a computing device receives a risk factor for an employee, the risk factor comprising a probability of code created by the employee including bugs and in response to receiving the risk factor for the employee, provides the risk factor to a management system. The management system can automatically notify a supervisor when the risk factor exceeds an allowable threshold. The management system can automatically notify the employee when the risk factor exceeds an allowable threshold. The management system can notify all or some of the members of a team to which the employee belongs of the risk factor associated with the employee. The risk results for a developer can be computed by combining risk factors associated with each line of buggy source code. The risk factor can be computed for a specified timeframe. A notification can be provided to an employee whose risk factor is outside of a normal range. Described herein is a device comprising a memory, a processor connected to the memory where the processor is configured to assess a risk factor associated with code created by an employee; and send the risk factor to a management system. Metrics can be used to determine probability of code including bugs. A probability of code including bugs can be used to perform a data-driven determination of rewards. The processor can track performance of an employee over time. The processor can combine risk factor with manager observations, allowing for capture and consideration of elements of the employee's work not captured by metrics. The processor can automatically perform a management action comprising promotion or dismissal.

### Exemplary Operating Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-binary instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above.

Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include binary instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system, comprising:
a memory;
a processor connected to the memory, the processor configured to:
receive a request for a risk factor for an employee, the risk factor comprising a likelihood that software code written by the employee includes bugs;
programmatically assess the risk factor for the employee using bug data; and
provide the risk factor to a human resources management system, wherein the risk factor is used to provide bug-based information to a corporate review and reward process as a way of assessing performance of the employee.

2. The system of claim 1, wherein the management system uses the risk factor for the employee to determine the quality of developer's code.

3. The system of claim 1, wherein a software repository comprising bug data for the employee is accessed to compute the risk factor.

4. (canceled)

5. The system of claim 1, wherein a plurality of software repositories are accessed for bug data to determine a risk factor for the employee.

6. The system of claim 1, further comprising a visualization that indicates a probability of code created by the employee including bugs.

7. The system of claim 1, wherein the risk factor is used to automatically determine reward levels.

8. A method comprising:
receiving by a processor of a computing device, a programmatically-determined risk factor for an employee, the risk factor comprising a probability of code created by the employee including bugs;
in response to receiving the risk factor for the employee, providing the risk factor to a management system.

9. The method of claim 8, wherein the management system automatically notifies a supervisor when the risk factor exceeds an allowable threshold.

10. The method of claim 8, wherein the management system automatically notifies the employee when the risk factor exceeds an allowable threshold.

11. The method of claim 8, wherein the management system notifies all the members of a team to which the employee belongs of the risk factor associated with the employee.

12. The method of claim 8, wherein the risk factor for a developer can be computed by combining risk factors associated with each line of buggy source code.

13. The method of claim 8, wherein the risk factor is computed for a specified timeframe.

14. The method of claim 8, wherein a notification is provided to an employee whose risk factor is outside of a normal range.

15. A device comprising:
a memory;
a processor, the processor configured to:
programmatically assess a risk factor associated with code created by an employee, the risk factor comprising a likelihood that software code written by the employee includes bugs; and
send the risk factor to a management system, wherein the risk factor is used to provide bug-based information to a corporate review and reward process as a way of assessing performance of the employee.

16. The device of claim 15, wherein the processor is further configured to:
use metrics to determine probability of code including bugs.

17. The device of claim 15, wherein the processor is further configured to:
use a probability of code including bugs to perform a data-driven determination of rewards.

18. The device of claim 15, wherein the processor is further configured to:
track performance of an employee over time.

19. The device of claim 15, wherein the processor is further configured to:
combine risk factor with manager observations, allowing for capture and consideration of elements of the employee's work not captured by metrics.

20. The device of claim 15, wherein the processor is further configured to:
automatically perform a management action comprising a promotion or dismissal.
